(19) United States
(12) Patent Application Publication
(10) Pub. No.: US 2018/0285519 A1
(43) Pub. Date: Oct. 4, 2018

(54) PHYLOGENY TREE GENERATION FROM MIXED SAMPLES

(71) Applicant: Brown University, Providence, RI (US)

(72) Inventors: Benjamin J. Raphael, Princeton, NJ (US); Mohammed El-Kebir, Princeton, NJ (US); Gryte Satas, Providence, RI (US)

(21) Appl. No.: 15/858,333

(22) Filed: Dec. 29, 2017

Related U.S. Application Data
(60) Provisional application No. 62/440,563, filed on Dec. 30, 2016.

(51) Int. Cl. G06F 19/14; G06F 19/22; G06F 19/26

(52) U.S. Cl. CPC G06F 19/14; G06F 19/26; G06F 19/22

(57) ABSTRACT

Methods and systems for generating character-based phylogeny trees from heritable data from mixture samples are provided. An example method for generating character-based phylogeny trees from heritable data for at least one mixture sample includes the step of generating a plurality of character-state trees based on the data. Each of the character-state trees comprises an arrangement of character-states associated with a particular character. The method also includes the steps of generating a pairwise compatibility graph for the character-state trees and identifying at least one maximal clique within the pairwise compatibility graph. The method additional includes the step of generating at least one phylogeny tree based on the identified at least one maximal clique.

### CROSS-REFERENCE TO RELATED APPLICATIONS

This application claims the benefit of provisional application Ser. No. 62/440,563, filed Dec. 30, 2016, which application is incorporated herein by reference in its entirety.

### GOVERNMENT LICENSE RIGHTS

This invention was made with government support under IIS61016648 awarded by the National Science Foundation (NSF) and R01HG005690 and R01HG007069 awarded by the National Institutes of Health (NIH). The government has certain rights in the invention.

### INCORPORATION BY REFERENCE

Details regarding the phylogeny tree generation, system and methods, in addition to those discussed herein, are also provided in the papers Inferring the Mutational History of a Tumor Using Multi-state Perfect Phylogeny Mixtures, El-Kebir et al., Cell Systems 3:43-53, Jul. 27, 2016, and Multi-State Perfect Phylogeny Mixture Deconvolution and Applications to Cancer Sequencing, El-Kebir, et al., arXiv preprint arXiv:1604.02605, Apr. 9, 2016, the entireties of which are incorporated herein.

### BACKGROUND

Generally, phylogenetics refers to the evolutionary relationships between members of a group. A phylogenetic tree can be used to represent the evolutionary relationships between those members. For example, a phylogenetic tree can be used to represent the evolutionary relationship between multiple cell samples extracted from a particular individual. Phylogenetic trees can be used, for example, to understand a disease, guide research into therapy, and determine treatment options. The phylogenetic tree cannot be determined directly in most cases.

Cancer is an evolutionary process, characterized by the accumulation of somatic mutations in a population of cells. As such, tumors are a heterogeneous mixture of cells with different complements of somatic mutations. Intra-tumor heterogeneity can be quantified e.g., by sequencing DNA from one or more samples of a tumor. A simple characterization of intra-tumor heterogeneity classifies mutations as clonal (present in all tumor cells) versus subclonal (present in a subset of tumor cells).

Importantly, the process of clonal evolution in a tumor occurs at the level of single cells. In phylogenetic terminology, the somatic evolutionary process is modeled by a phylogenetic tree, whose leaves correspond to extant entities called taxa and whose edges describe the ancestral relationships among the taxa. The taxa are the individual cells in a tumor. Yet, due to technical and financial constraints, the majority of cancer sequencing projects do not sequence individual cells but rather bulk tumor samples containing thousands to millions of cells. All of the datasets from The Cancer Genome Atlas (TCGA) and nearly all of the datasets from the International Cancer Genome Consortium (ICGC) measure mutations in a single bulk tumor sample.

More recently, sequencing of multiple bulk samples from the same tumor has been undertaken. Phylogenetic trees can be used to represent the relationships among these individual samples. Importantly, bulk sequencing data do not reveal the presence/absence of a mutation in an individual cell; rather, the fraction of DNA sequence reads that indicate a mutation provide an estimate of the fraction of cells that contain the mutation. In phylogenetic terminology, individual taxa are not measured, but rather mixtures of taxa. Thus, proper phylogenetic analysis of bulk cancer sequencing data demands specialized techniques that handle such mixtures.

It is with respect to this general technical environment that aspects of the present technology disclosed herein have been contemplated.

### SUMMARY

This summary is provided to introduce a selection of concepts in a simplified form that are further described in the Detailed Description section. This summary is not intended to identify key features or essential features of the claimed subject matter, nor is it intended to be used as an aid in determining the scope of the claimed subject matter.

Non-limiting examples of the present disclosure describe computer-implemented methods and systems for generating character-based phylogeny trees from heritable data from one or more mixture samples. A first aspect is a method for generating character-based phylogeny trees from heritable data for at least one mixture sample, the method comprising: generating a plurality of character-state trees based on the heritable data, each of the character-state trees comprising an arrangement of character-states associated with a particular character; generating a pairwise compatibility graph for the character-state trees; identifying at least one maximal clique within the pairwise compatibility graph; and generating at least one phylogeny tree based on the identified at least one maximal clique.

Another aspect is a system for generating character-based phylogeny from heritable data for at least one mixture sample, the system comprising: at least one processor; and memory, operatively connected to the at least one processor and storing instructions that, when executed by the at least one processor, cause the at least one processor to: generate a plurality of character-state trees based on the heritable data, each of the character-state trees comprising an arrangement of character-states associated with a particular character; generate a pairwise compatibility graph for the character-state trees; identify at least one maximal clique within the pairwise compatibility graph; and generate at least one phylogeny tree based on the identified at least one maximal clique.

Yet another aspect is a tangible computer readable storage medium containing computer executable instructions which, when executed by a computer, perform a method for generating character-based phylogeny trees from heritable data for at least one mixture sample, the method comprising: generating a plurality of character-state trees based on the data, each of the character-state trees comprising an arrangement of character-states associated with a particular character; generating a pairwise compatibility graph for the character-state trees; identifying at least one maximal clique within the pairwise compatibility graph; and generating at least one phylogeny tree based on the identified at least one maximal clique.

Yet one more aspect is a method for generating character-based phylogeny trees from nucleic acid sequencing data for at least one mixture sample, the sequencing data comprising variant allele frequencies (VAFs) of single nucleotide variants, breakpoint frequencies of structural variants, copy number data, and nucleic acid mutation frequency data, the method comprising: generating a frequency tensor based on the sequencing data, the frequency tensor comprising frequency values for a plurality of characters in a plurality of character-states for each mixture sample of the at least one mixture sample; generating a plurality of character-state trees vertices corresponding to the plurality of character state trees based on the sequencing data, each of the character-state trees comprising a sequence of character-states associated with a particular character; generating a pairwise compatibility graph having vertices corresponding to the plurality of character state trees by: selecting a character state tree for a first character; selecting a character state tree for a second character; determining whether a perfect phylogeny tree exists that contains both the selected character state tree for the first character and the selected character state tree for the second character; and when determined that a perfect phylogeny tree exists that contains both the selected character state tree for the first character and the selected character state tree for the second character, adding an edge to the pairwise compatibility graph between a vertex associated with the selected character state tree for the first character and a vertex associated with the selected character state tree for the second character; and identifying at least one maximal clique within the pairwise compatibility graph; and generating at least one phylogeny tree based on the identified at least one maximal clique, wherein the sequencing data for the at least one mixture sample comprises bulk nucleic acid sequencing data for the at least one mixture sample and the copy number data comprises read-depth ratios and B-allele frequencies from copy number aberrations.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures. As a note, the same number represents the same element or same type of element in all drawings.

FIG. 1 is an example of a suitable operating environment for implementing aspects of the disclosure.

FIG. 2 is an example of a computing network.

FIG. 3 is an example method of generating phylogeny trees performed by some embodiments of the systems and methods disclosed herein.

FIG. 4 is an example method used in generating a pairwise compatibility graph performed by some embodiments of the systems and methods disclosed herein.

FIG. 5 includes an illustration that shows a phylogeny tree that matches a matrix.

FIG. 6 is an illustration of an example in which a clonal tree is generated to represent the tumor cells from mixture samples.

FIG. 7 is another illustration of an example of the systems and methods for generating phylogenic trees described herein.

FIG. 8 is an example of real data results. (a) The computed tree for a chronic lymphocytic leukemia patient (CLL077) with a copy-neutral loss of heterozygosity (CN-LOH) event in red. (b) The computed tree for a prostate cancer patient (A22) with a single-copy deletion (SCD) event in blue. (c) Usage matrix for CLL077 shows that the samples (columns) are mixed and consist of many clones (rows) as indicated by the coloring, (d) Usage matrix for A22 shows that samples consist of small subsets of clones, which reflect their distinct spatial locations.

FIG. 9 is an example of an enumerated solution space of real data instances. Vertices correspond to the vertices of the solution trees and each edge is labeled by the number of solutions in which it occurs. (a) Tumor CLL077 (20 solutions). (Note: a mutation in gene GPR158 is not shown here as it was not contained in any of the 30 solutions). (b) Tumor A22 (24288 trees).

### DETAILED DESCRIPTION

Various aspects are described more fully below with reference to the accompanying drawings, which form a part hereof, and which illustrate aspects of the present disclosure. These examples may be implemented in many different forms and aspects of the present disclosure should not be construed as being limited to the examples set forth herein.

Non-limiting and non-exclusive examples of the present disclosure describe methods and systems for generating phylogeny trees.

The phylogenetic techniques disclosed herein can be used to reconstruct the evolutionary history of the tumor. Since one of the goals of cancer phylogenetic studies is to understand ancestral relationships among mutations, character-based phylogenetic techniques can be used.

In these character-based phylogenies, each of the taxa comprises an arrangement of characters, wherein each character exhibits one of several distinct states. Typically, at least some of the characters can exhibit more than two states.

For example, with respect to a nucleic acid sequence, characters can represent positions in the sequence at various scales from a single nucleotide, to a particular domain, regulatory element, gene, or even an entire chromosome. In some embodiments, characters correspond to genomic loci.

The states represent properties of characters such as the number and types of copies of the character that are present in the genome. When characters are from a genome, normally, two copies of the character will exist: a maternal copy from the maternal chromosome and a paternal copy from the paternal chromosome. However, mutations of one or both of the copies can occur during cell replication, and copies may be gained and lost due to changes in the number of chromosomes.

Indeed, cancer can be driven by somatic mutations that accumulate in the genome over an individual's lifetime, with additional contributions from epigenetic and transcriptomic alterations. These somatic mutations range in scale from single-nucleotide variants (SNVs), insertions and deletions of a few to a few dozen nucleotides (indels), larger copy-number aberrations (CNAs) and large-genome rearrangements, also called structural variants (SVs). Thus, for example, apart from SNVs, additional types of mutations that may be present in tumors include, for example, copy-neutral loss-of-heterozygosity (CN-LOH), single-copy deletion (SCD) and single-copy amplification (SCA).

Moreover, some mutations e.g., SNVs can be in regions that are unaffected by CNAs, or that have undergone CNA events that are CN-LOH, SCD or SCA events.

Epigenetic changes, alone or in combination with genetic changes, also can affect tumor formation and progression. Epigenetic events can be mediated by e.g., DNA methylation and/or chromatin remodeling (e.g., via histone acetylation, methylation and phosphorylation, which can, for example, lead to the formation of transcriptionally repressive chromatin states resulting in gene silencing).

Although alternatives are possible, the states are typically represented in terms of the number of copies of the character present.

In one embodiment, the present invention provides methods, systems, and tangible computer readable storage mediums for generating character-based phylogeny trees from heritable data for at least one mixture sample.

In some embodiments, the heritable data comprises genetic data.

In one embodiment, the genetic data comprises nucleic acid sequencing data.

In another embodiment, the nucleic acid sequencing data comprises DNA or RNA sequencing data.

In other embodiments, the heritable data comprises epigenetic data.

In one embodiment, the epigenetic data comprises DNA methylation data.

In another embodiment, the epigenetic data comprises histone modification data.

In some embodiments, the histone modification data comprises histone acetylation, methylation, or phosphorylation, and combinations thereof.

In still further embodiments, the heritable data comprises a combination of genetic and epigenetic data.

In an embodiment, the states for a particular character can be represented using a triple (x, y, z) of integer values, where x represents the number of maternal copies of the character present, y represents the number of paternal copies of the character present, and z represents the number of maternal or paternal copies that are mutated. Although the copies are referred to as maternal and paternal copies, it is not actually necessary to determine which copies of the characters came from a maternal or paternal germline. This terminology is used to reflect that two different copies of the character are present in a healthy diploid cell. In some embodiments, it is assumed that the number of maternal copies is equal to greater than the number of paternal copies (i.e., x>=y).

Because it is possible that both the maternal copy and the paternal copy can be mutated, some embodiments use z to represent the greater of the number of mutated maternal copies and mutated paternal copies. Alternatively, some embodiments, represent the state using a quadruple of integers in which separate value are used to represent the number of mutated maternal copies and the number of mutated paternal copies. A typical, healthy diploid cell would have a state of (1, 1, 0), indicating one maternal copy, one paternal copy, and zero of those copies are mutated. In some embodiments, this state of (1, 1, 0) is considered the initial state for a character (i.e., before any mutations or copy number aberrations occur).

The systems and methods disclosed herein are capable of generating a character-based phylogeny tree in which at least some of the characters in the tree are represented using more than two states. These systems and method are more accurate than two-state models at representing observed sequencing data from samples from tissues such as tumor cells. In contrast, techniques that generate two-state models simply represent a position in a sequence as mutated or not mutated. Accordingly, two-state models are unable to accurately represent e.g., both single nucleotide variants and copy number aberrations.

Embodiments of the phylogeny trees described herein are used to represent a plurality of taxon identified in the bulk heritable data. In some embodiments, the phylogeny trees comprise a vertex-labeled tree whose leaves are labeled by the states of each taxon and whose internal vertices are labeled by an ancestral state for each character, such that the resulting tree maximizes an objective function (e.g., maximum parsimony or maximum likelihood) over all such labeled trees. The phylogeny trees can be generated based on bulk heritable data (e.g., bulk cancer sequencing data), where the input is not the set of states for each taxon but rather mixtures of these states. The described systems and methods generate a phylogeny tree whose leaves represent the observed mixture samples and determine the mixing proportions of the leaves that correspond to the frequencies of the characters observed in the mixture samples.

Although many of the embodiments disclosed herein relate to generating phylogeny trees for cancer cells, other embodiments are possible as well. In some embodiments, phylogenetic trees are generated based on metagenomics samples, samples of cells that undergo somatic hypermutation (e.g., immune systems cells), prenatal samples, and samples of circulating nucleic acid during cancer or other biological processes.

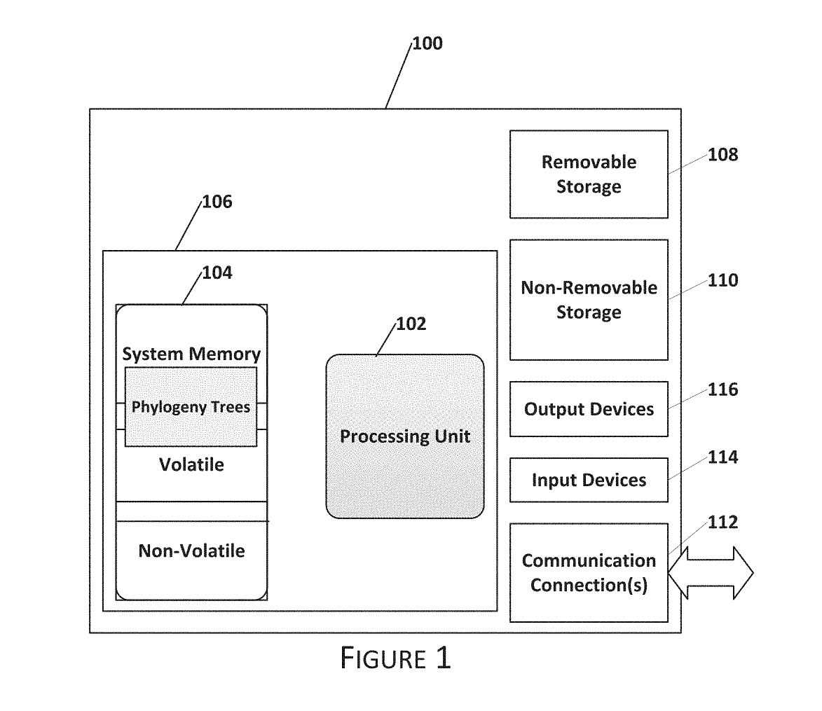

FIG. 1 and the accompanying discussion in this specification are intended to provide a brief general description of a suitable computing environment in which the present invention and/or portions thereof may be implemented. Aspects of the present disclosure as described herein may be implemented as computer-executable instructions such as by program modules or applications, being executed by a computer, such as a client workstation or a server, including a server operating in a cloud environment. Generally, program modules or applications include routines, programs, objects, components, engines, data structures, and the like that perform particular tasks or implement particular abstract data types. Moreover, it should be appreciated that aspects of the present disclosure or portions thereof may be practiced with other computer system configurations, including hand-held devices, multi-processor systems, microprocessor-based programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices. The figures depict the general structure geometries of the technologies described herein.

FIG. 1 illustrates one example of a suitable operating environment 100 in which one or more of the present examples according to the disclosure may be implemented.

In its most basic configuration, operating environment 100 typically includes at least one processing unit 102 and memory 104. Depending on the desired configuration and type of computing device used to implement the memory 104 (storing, among other things, phylogeny trees constructed as described herein) may be volatile (such as RAM), non-volatile (such as ROM, flash memory, etc.), or some combination of the two. Memory 104 may store computer instructions related to performing phylogeny tree generation methods disclosed herein. Memory 104 may also store computer-executable instructions that may be executed by the processing unit 102 to perform the methods disclosed herein.

The operating environment 100 may also include storage devices (removable 108, and/or non-removable 110) including, but not limited to, magnetic or optical disks or tape. Similarly, environment 100 may also have input device(s) 114 such as keyboard, mouse, pen, voice input, etc. and/or output device(s) 116 such as a display, speakers, printer, etc. Also included in the environment may be one or more communication connections, 112, such as LAN, WAN, point to point, etc.

Operating environment 100 typically includes at least some form of computer readable media. Computer readable media can be any available media that can be accessed by processing unit 102 or other devices comprising the operating environment. By way of example, and not limitation, computer readable media may comprise computer storage media and communication media. Computer storage media includes volatile and non-volatile, removable and non-removable media implemented in any method or technology for storage of information such as computer readable instructions, data structures, program modules, or other data. Computer storage media includes, RAM, ROM, EEPROM, flash memory or other memory technology, CD-ROM, digital versatile disks (DVD) or other optical storage magnetic cassettes, magnetic tape, magnetic disk storage or other magnetic storage devices, or any other medium which can be used to store the desired information. Communication media embodies computer readable instructions, data structures, program modules, or other data in a modulated data signal such as a carrier way or other transport mechanism and includes information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 100 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

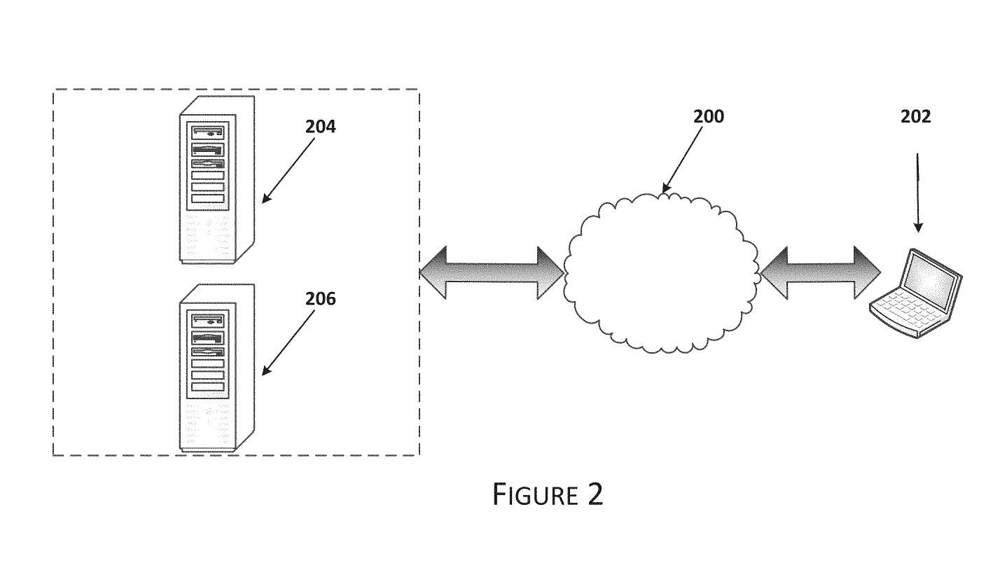

FIG. 2 is an example of a network 200 in which the various systems and methods disclosed herein may operate. In examples, client device 202, may communicate with one or more servers, such as servers 204, via a network 208. According to aspects of the disclosure, a client device may be a laptop, a personal computer, a smart phone, a tablet computing device, or any other type of computing device. Network 208 may be any type of network capable of facilitating communications between the client device and one or more servers 204 and 206. Examples of such networks include, but are not limited to, LANs, WANs, cellular networks, and/or the Internet.

In aspects according to the disclosure, the various systems and methods disclosed herein may be performed by one or more server devices. For example, in one example, server 204 may be employed to perform the phylogeny tree generation methods disclosed herein. Client device 202 may interact with server 204 via network 208 in order to access or provide information such as, heritable (e.g., genetic or epigenetic) information, including bulk sequencing data, and phylogeny trees, and/or functionality disclosed herein. In further aspects, the client device 202 may also perform functionality disclosed herein.

In alternative examples, the methods and systems disclosed herein may be performed using a distributed computing network, or a cloud network. In such examples, the methods and systems disclosed herein may be performed by two or more servers 204 and 206. Although particular network examples are disclosed herein, one of skill in the art will appreciate that these systems and methods may be performed using other types of configurations.

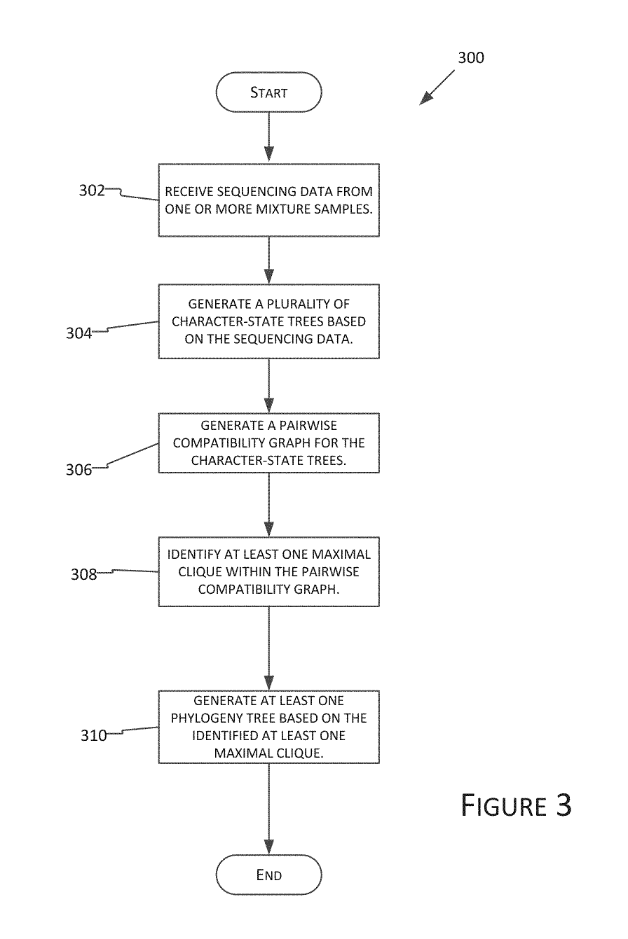

FIG. 3 is an example method of generating phylogeny trees performed by some embodiments of the systems and methods disclosed herein.

At operation 302, sequencing data is received from one or more mixture samples. Often, sequencing data is received from at least two mixture samples. Sometimes, the mixture data can be received from more than two mixtures such as five or ten or more mixture samples. In some embodiments, the sequencing data includes one or more of variant allele frequencies of single nucleotide variants and copy number data. The copy number data may include read-depth ratios and B-allele frequencies from copy number aberrations.

The sequencing data comprises multiple types of data generated from the mixture sample. The sequencing data can comprise variant allele frequencies of single nucleotide variants and/or breakpoint frequencies of structural variants. The sequencing data can also include read depth ratios and B-allele frequencies and/or other data derived therefrom such as copy numbers and mixing proportions of copy number aberrations. In some embodiments, after receiving the sequencing data, copy number and mixing proportions of copy number aberrations are derived from the read depth ratios and B-allele frequency data in the sequencing data.

In some embodiments, the received data is processed to generate a frequency tensor for each character state in each of the samples. For example, the frequency tensor may comprise a three-dimensional array of values where one dimension represents the mixture sample, one dimension represents the character, and one dimension represents the state. A frequency value is then stored in the three-dimensional array for each of the character-state-sample combinations representing the frequency with which that particular character-state was observed within the particular mixture sample. Across a particular mixture sample, the sum of the frequency values for a particular character will equal 1.

At operation 304, a plurality of character state trees is generated based on the sequencing data. As used herein, character-state trees and variants thereof refers to trees that represent a set of character-states and transitions between those character-states for a single character.

Typically, the character state trees begin with an initial character-state of (1, 1, 0) (i.e., a healthy diploid cell having one maternal copy, one paternal copy, and zero mutations in those copies). The character state trees also comprise one or more transitions from the initial character-state to another character-state. In some embodiments, each of the transitions comprise a single change to the character such as a mutation to one of the maternal or paternal copies, or a copy number aberration resulting in one additional copy of either the maternal or paternal copy being present. In other words, a single value of the integer triple changes by one at each state transition.

In some embodiments, the plurality of character state trees is generated by enumerating all of the valid state trees that start at the initial character-state and include all of the character-states that appear in the data from the mixture samples. Some embodiments apply additional constraints when enumerating the valid character state trees. For example, some embodiments impose a no homoplasy constraint, meaning that a character can change character-states multiple times, but cannot return to a previous character-state (i.e., a character can only transition to a particular character-state once).

Other conditions can be applied to determine whether the character state trees are valid too. For example, the frequencies of parents (i.e., the character-state from which a transition begins) and children (i.e., the character-state at which a transition ends). In some embodiments, a constraint is included to require that the frequency of a parent exceeds the cumulative frequency of its children. Other constraints can be included as well. Although alternatives are possible, any character state trees that conform to all of the constraints are included in the plurality of generated state trees.

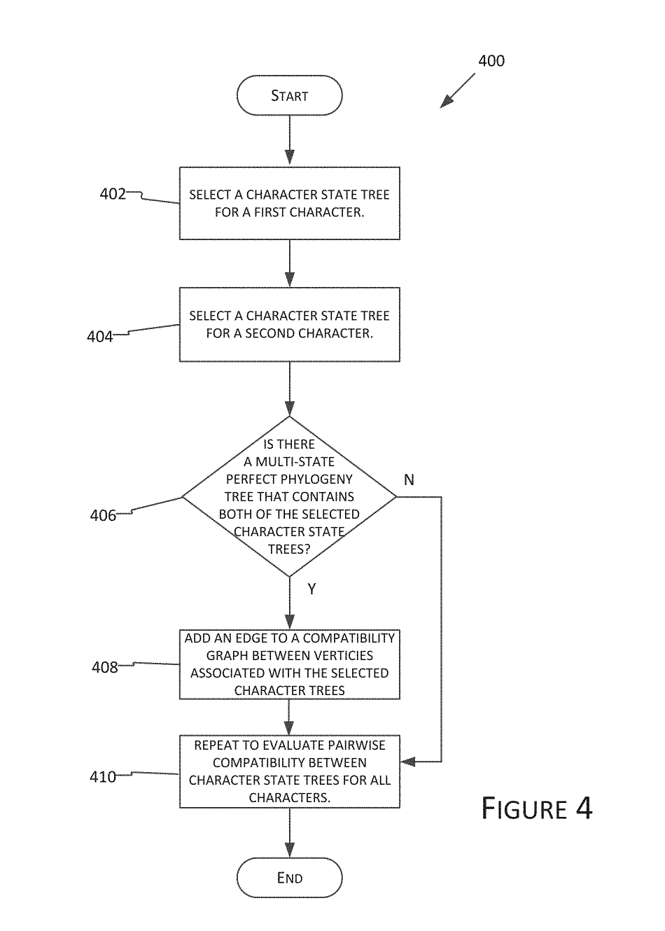

At operation 306, a pairwise compatibility graph is generated for the character state trees. In some embodiments, the pairwise compatibility graph is composed of vertices that represent character state trees and edges between vertices that are compatible. The pairwise compatibility graph is generated by evaluating the compatibility of a first character state tree with a second character state tree. If the pair of character state trees are compatible, an edge is added to the pairwise compatibility graph between vertices associated with the character state trees. An example method for generating a pairwise compatibility graph is illustrated and described with respect to FIG. 4.

At operation 308, at least one maximal clique is identified within the pairwise compatibility graph. A clique is a group of nodes in the graph that are all pairwise compatible with each other. A maximal clique is clique that cannot be expanded by adding another node in the pairwise compatibility graph (i.e., there are no remaining non-clique nodes that are pairwise compatible with all of the nodes in the clique).

In some embodiments, a plurality of maximal cliques is identified within the pairwise compatibility graph. For example, some embodiments enumerate all of the maximal cliques within the pairwise compatibility. The maximal cliques can be enumerated using various techniques. In some embodiments, the maximal cliques are enumerated using a depth-first search through the nodes of the pairwise compatibility graph.

At operation 310, a phylogeny tree based on the identified at least one maximal clique is generated. In some embodiments, a phylogeny tree is generated by generating a spanning tree from a maximal clique. The spanning tree can be generated using various techniques such as the Gabow-Myers algorithm. Because multiple spanning trees can be generated from the graph of the maximal clique, various optimization techniques are used. For example, linear programming can be used to generate a tree that is optimized based on its conformance to frequency tensor data.

In some embodiments, a phylogeny tree is generated for each of the maximal cliques identified at operation 308. In some embodiments, a phylogeny tree is generated for a portion of the maximal cliques such as those that can be generated within a particular time period, those exceeding a certain size, or those that include a particular character, character state tree, or edge.

In some embodiments, each of the generated phylogeny trees is considered to be equally likely. In some embodiments, the generated phylogeny trees are summarized to identify commonalities, differences, or meaningful insights.

FIG. 4 is an example method used in generating a pairwise compatibility graph performed by some embodiments of the systems and methods disclosed herein.

At operation 402, a first character state tree is selected for a first character. In some embodiments, an ordered list of characters is maintained. The list may be ordered by any criterion or may even be ordered randomly. A first character in the list can then be identified for purposes of generating the pairwise compatibility graph. Similarly, the character state trees for the first character can be stored in an ordered list, which can be ordered by any criterion or even randomly. In some embodiments, the first character state tree for the character that has not been evaluated is selected.

At operation 404, a character state tree for a second character is selected for comparison with the character state tree from the first character. In some embodiments, the compatibility of character state trees is evaluated in a depth-first fashion where the character state tree for the first character in operation 402 is compared to each of the character state trees from the second character. Thereafter, the selected character state tree from the first character can, for example, be compared to each of the character state trees from a third character, etc.

At operation 406, it is determined whether the selected character state trees are compatible with each other. For example, some embodiments determine whether there is a multi-state perfect phylogeny tree that contains both of the selected character state trees. If so, it is determined that the character state trees are compatible and the method proceeds to operation 406. If not, it is determined that the character state trees are not compatible with each other and the method proceeds to operation 410.

At operation 408, an edge is added to the pairwise compatibility graph between vertices associated with the selected character tree. The pairwise compatibility tree can, for example, be stored in memory using any appropriate data structure for storing trees or graphs.

At operation 410, the method 400 is repeated to evaluate pairwise compatibility of other pairs of character state trees. Typically, the method 400 is performed repeatedly until all of the character state trees for each character are compared to each of the character states trees for each of the other characters. In this manner, the pairwise compatibility graph will include edges between all of the character states that are compatible.

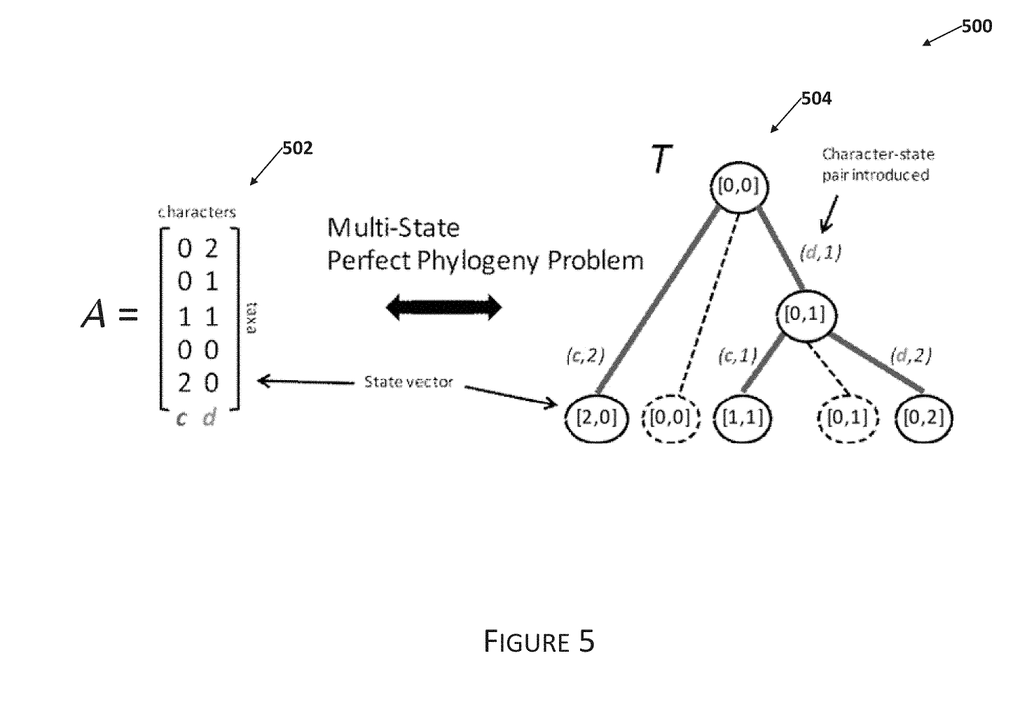

FIG. 5 includes an illustration 500 that shows a phylogeny tree 502 that matches a matrix 504. The rows of the matrix 504 are state vectors of the taxa present in the sequencing data. In this example, two characters (c, d) are shown.

The tree 502 is a tree that satisfies the infinite alleles assumption (i.e., no homoplasy) and has leaves that correspond to the taxa of the matrix 504. The tree 502 can be generated by the systems and methods disclosed herein.

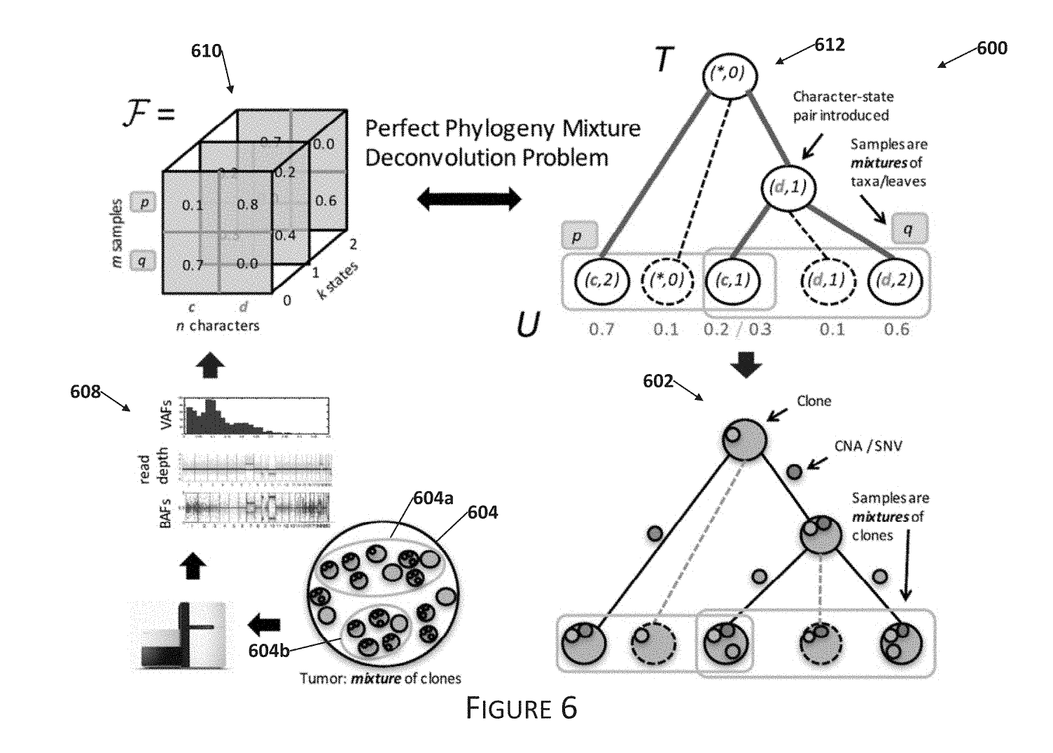

FIG. 6 is an illustration 600 of an example in which a clonal tree 602 is generated to represent the tumor cells from mixture samples 604.

In this example, the mixture samples 604 include mixture sample 604a and 604b. Of course, more than two mixture samples can be used by the systems and techniques disclosed herein. The mixture samples 604 are analyzed with sequencing equipment 606 to generate sequencing data 608. As described previously, the sequencing data 608 includes variant allele frequencies of single nucleotide variants, read depth ratios, and B-allele frequencies from copy number aberrations.

The sequencing data 608 is used to generate a frequency tensor 610. In the frequency tensor 610, a row labeled p corresponds to the mixture sample 604a and a row labeled q corresponds to the mixture sample 604b. The columns correspond to characters and the layers correspond to character states. Although the illustration 600 shows three layers for each character, it should be understood that not all characters will necessarily have the same number of states. The numbers in each cell of the frequency tensor 610 correspond to the frequency at which the particular character state appeared in the sequencing data.

The frequency tensor 610 is used to generate the phylogeny tree 612. The phylogeny tree 612 corresponds to the clonal tree 602.

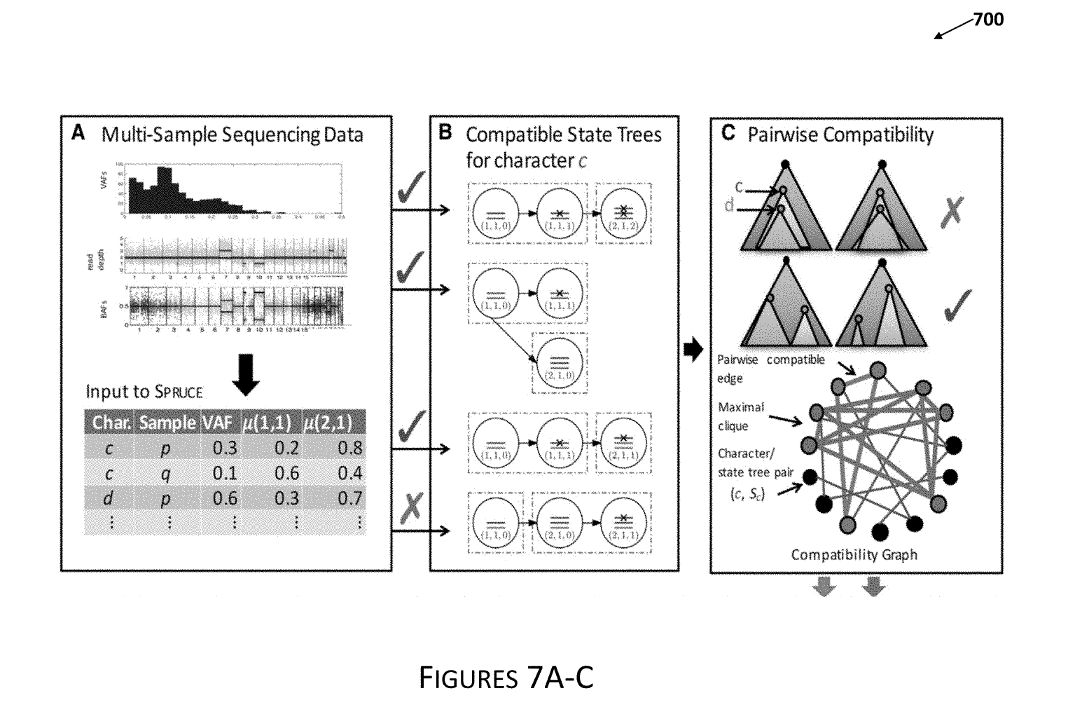

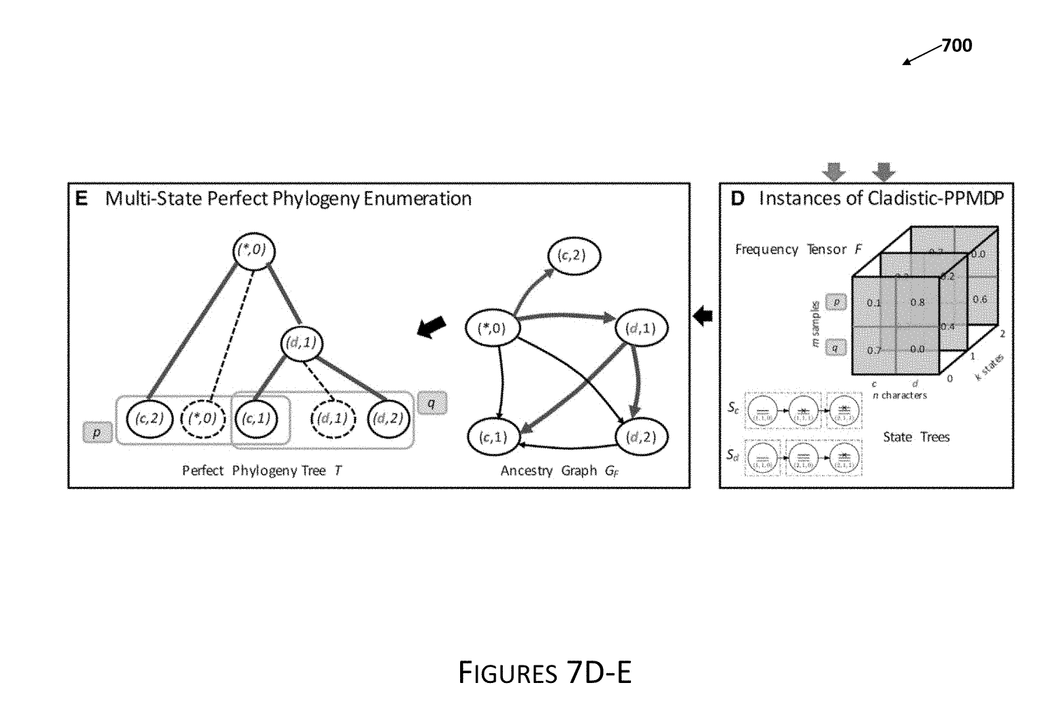

FIG. 7 is another illustration 700 of an example of the systems and methods for generating phylogenic trees described herein. At A, input bulk sequencing data, including VAFs of SNVs and the copy numbers and mixing proportions of CNAs, which are derived from read depth and B-allele frequencies, are shown.

At B, the bulk sequencing data is used with a multi-state model for the somatic mutational process to produce a collection of compatible state trees for each character.

At C, two character-state tree pairs are evaluated to determine compatibility. In some embodiment, a pair is compatible if there exists a perfect phylogeny tree that contains both. A pairwise compatibility graph is constructed by considering all such pairs. Maximal cliques are identified in the compatibility graph.

At D, an identified maximal clique is used to generate a frequency tensor F and collection S of state trees that are an input to the cladistic perfect phylogeny mixture deconvolution process (Cladistic-PPMDP).

At E, for each instance of a maximal clique, a multi-state ancestry graph (G_{F}) is constructed. The graph encodes potential ancestral relationships between character-state pairs. The system then computes multi-state perfect phylogeny trees having a maximum size and the corresponding usage matrices.

The aspects of the disclosure described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices can be employed to perform the functionality disclosed herein without departing from the scope of the disclosure.

### EXAMPLES

Herein below, the present invention will be described with reference to the Examples, but it is not to be construed as being limited thereto.

### Example 1

Algorithm 1
Algorithm 1: ENUMERATE(G,T,H)

```
  Input: Ancestry graph G_{(σ,s)}, perfect phylogeny tree T, frontier H
  Output: All complete perfect phylogeny trees that generate F and are
  consistent with S
  1 if H = ∅ and |V(T)| = |V(G)| then
  2  Return T
  3 else
  4  while H ≠ ∅ do
  5  (v_{(c,i)},v_{(d,j)}) ← POP(H)
  6  E(T) ← E(T) ∪ {(v_{(c,i)}, v_{(d,j)})}
  7  foreach (v_{(d,j)}, v_{(e,l)}) ϵ E(G) do
  8  if v_{(e,l)} ∉ V(T) and v₍ [symbol]  (t)) is the first vertex with
          character c on the path from v₍ [symbol]  ) to v_{(d,j)}
          and f_{P}⁺(D_{(d,j)}) ≥ f_{P}⁺(D_{(e,l)}) + Σ_{(f,a)} [symbol]  (d,j) f_{P}⁺(D_{(f,} [symbol]  )) then
  9  PUSH(H,(v_{(d,j)}, v_{(e,l)}))
10  foreach (v_{(e,l)},v_{(f,a)}) ϵ H do
11  if v_{(f,a)} = v_{(d,j)} then
12  Remove (v₍ [symbol]  ), v₍ [symbol]  )) from H
13  else if v_{(e,l)} = v_{(c,i)} and [symbol] [symbol]     p ϵ [m] such that f_{P}⁺(D_{(c,i)}) <
          f_{P}⁺(D_{(f,a)}) + Σ₍ [symbol]  )ϵ [symbol]   ( [symbol]   )f_{P}⁺(D₍ [symbol]  )) then
14  Remove (v_{(e,l)}, v_{(f,a)}) from H
15  ENUMERATE(G,T,H)
16  E(T) ← E(T)\{(v_{(c,i)}, v_{(d,j)})} [symbol]
indicates data missing or illegible when filed
```

### Example 2

Algorithm 2

Algorithm 2 gives the pseudo code of an enumeration procedure of all maximal valid trees given intervals [l_{p,(c,i)}, u_{p,(c,i)}] for each character-state pair (c, i) in each sample p. The initial call is NoisyEnumerate(G, {v_{(*,0)}}, δ_{(*, 0)}). The partial tree containing just the vertex v_{(*,0)} satisfies Invariant 1. The set δ_{(*, 0)} corresponds to the set of outgoing edges from vertex v_{(*,0)} of G_{(F,S)}, which by definition satisfies Invariant 2. Upon the addition of an edge (v_{(c,i)}, v_{(d,j)})∈H (line 5), Invariant 2 is restored by adding all outgoing edges from v_{(d,j)} whose addition results in a consistent partial tree T^{l} that satisfies (MSSC) for \hat{F} (lines 9-10) and by removing all edges from H that introduce a cycle (lines 12-13) or violate (MSSC) for F̂ (lines 14-15).

Note that, in line 13, the condition v_{(e,l)}=v_{(c,i)} is dropped as the newly added edge (v_{(c,i)}, v_{(d,j)}) may affect the frequencies F̂ of the vertices of the current partial tree T.

Since a maximal valid tree T does not necessarily span all the vertices, it may happen that for a character c not all states in S_{c} are present. We say that a maximal valid tree T is state complete if for each vertex v_{(c,i)} of T, all vertices v_{(c,j)} where j∈V (S_{c}) are also in V (T). Our goal is to report all maximal valid and state-complete trees. Therefore, we post-process each maximal valid tree T and remove all vertices v_{(c,i)} where there is a j∈V (S_{c}) such that v_{(c,j)}/∈V (T). The tree that we report corresponds to the connected component rooted at v_{(*,0)}. Since each maximal valid and state-complete tree is a partial valid tree rooted at v_{(*,0)}, our enumeration procedure reports all maximal valid and state-complete trees.

Algorithm 2: NOISYENUMERATING{G, T, H}

| | Input: Ancestry graph G [symbol] |
|---|---|
| | Output: All maximal valid perfect phylogenies that are consistent with [symbol] |
| 1 | if H = [symbol] then |
| 2 | Let T [symbol] be the [symbol] of T that only contains state-complete characters |
| 3 | Return T [symbol] |
| 4 | else |
| 5 | while H ≠ [symbol] do |
| 6 | [symbol] |
| 7 | E(T) ← E(T) [symbol] |
| 8 | foreach [symbol] do |
| 9 | if [symbol] and [symbol] is the first vortex with character [symbol] on the path from [symbol] |
| | and [symbol] then |
| 10 | [symbol] |
| 11 | foreach [symbol] do |
| 12 | if [symbol] then |
| 13 | Remove [symbol] from H |
| 14 | else if [symbol] then |
| 15 | Remove [symbol] from H |
| 16 | NOISYENUMERATING{G, T, H} |
| 17 | E(T) ← E(T) \ [symbol] |

[symbol]

indicates data missing or illegible when filed

### Example 3

Chronic Lymphocytic Leukemia (CLL) tumor

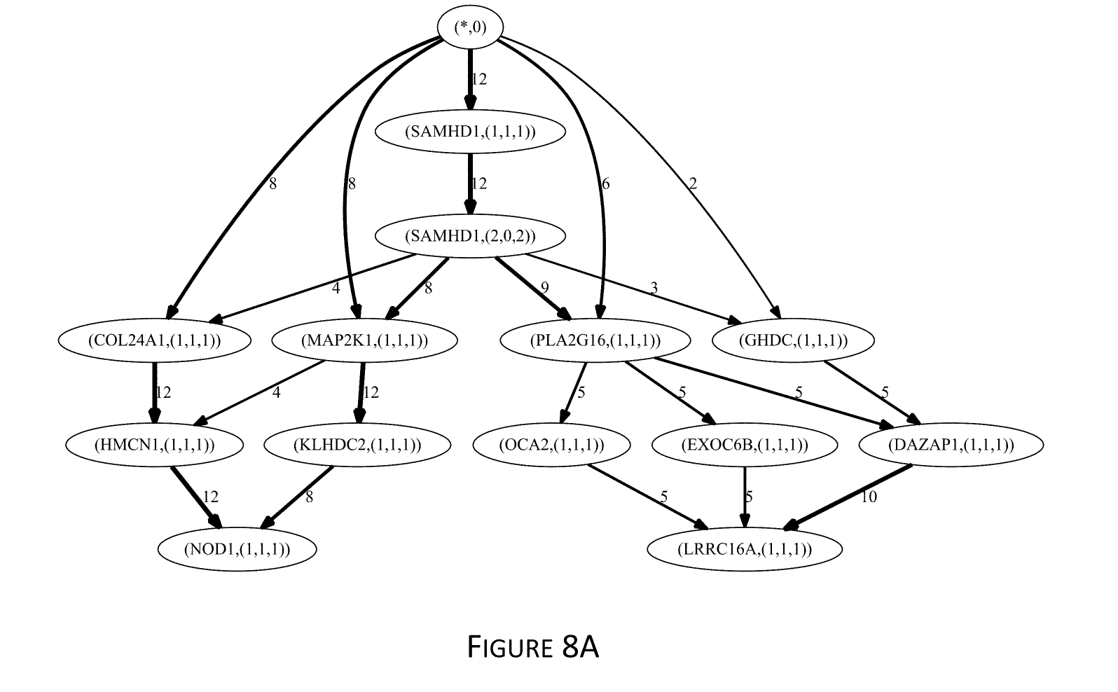

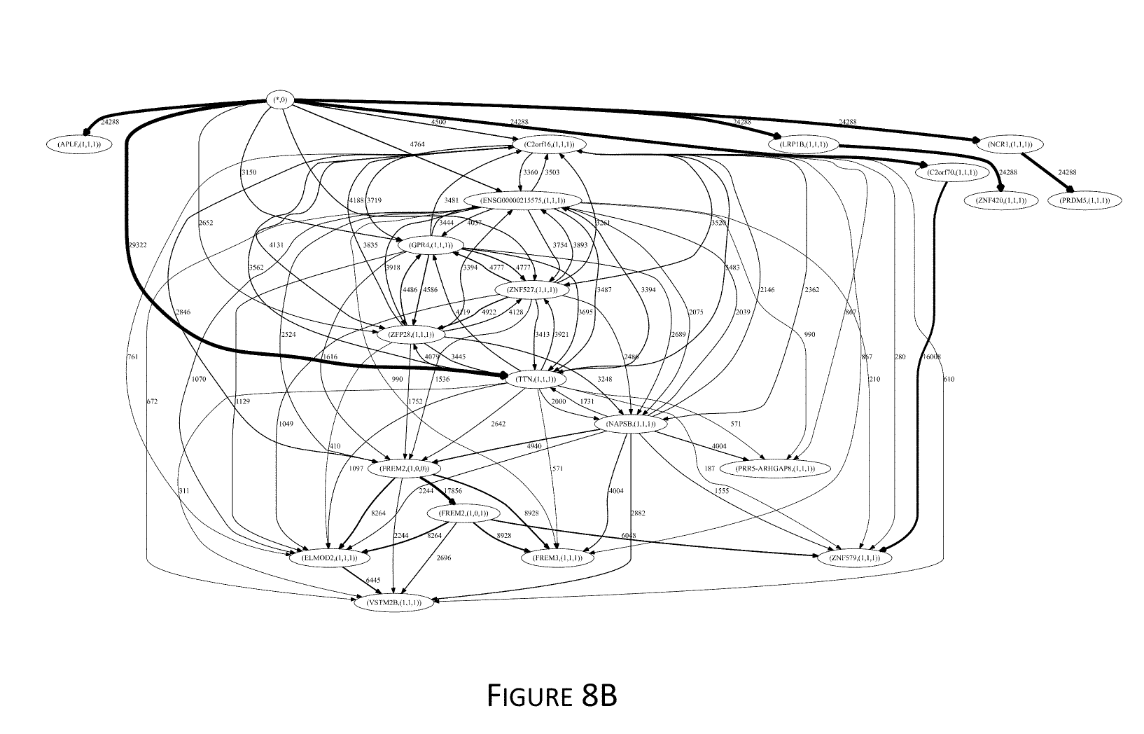

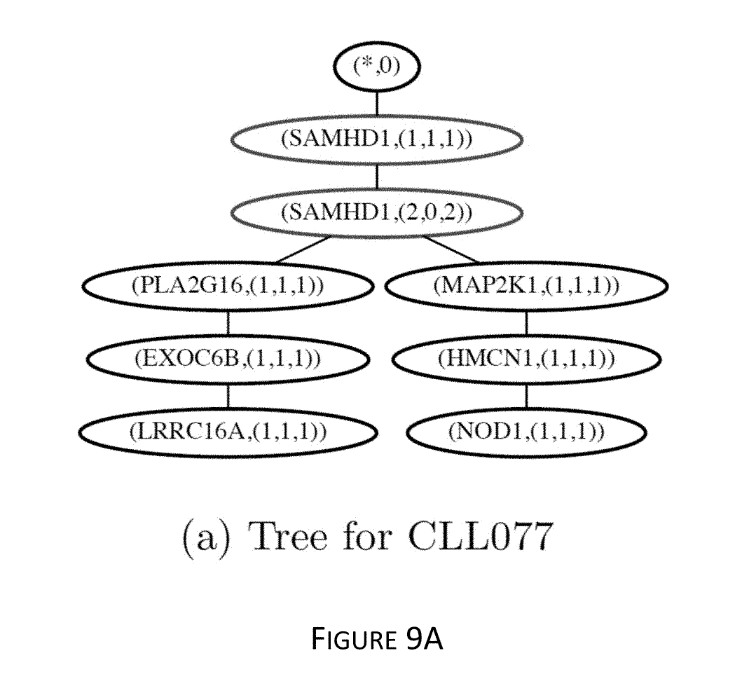

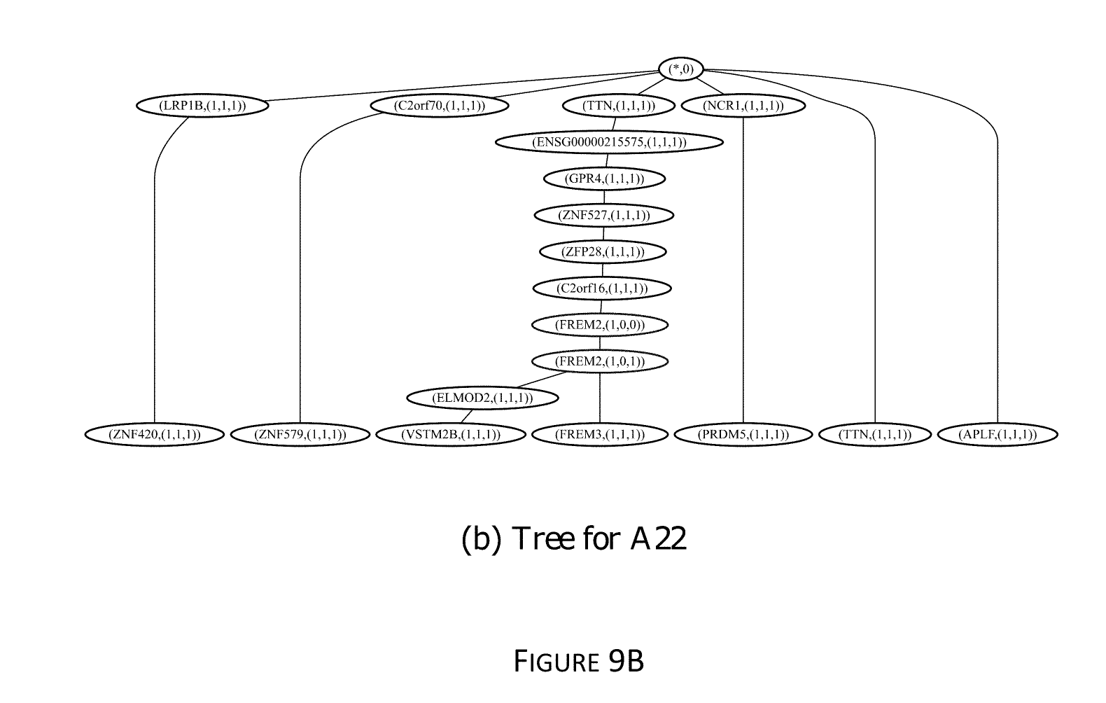

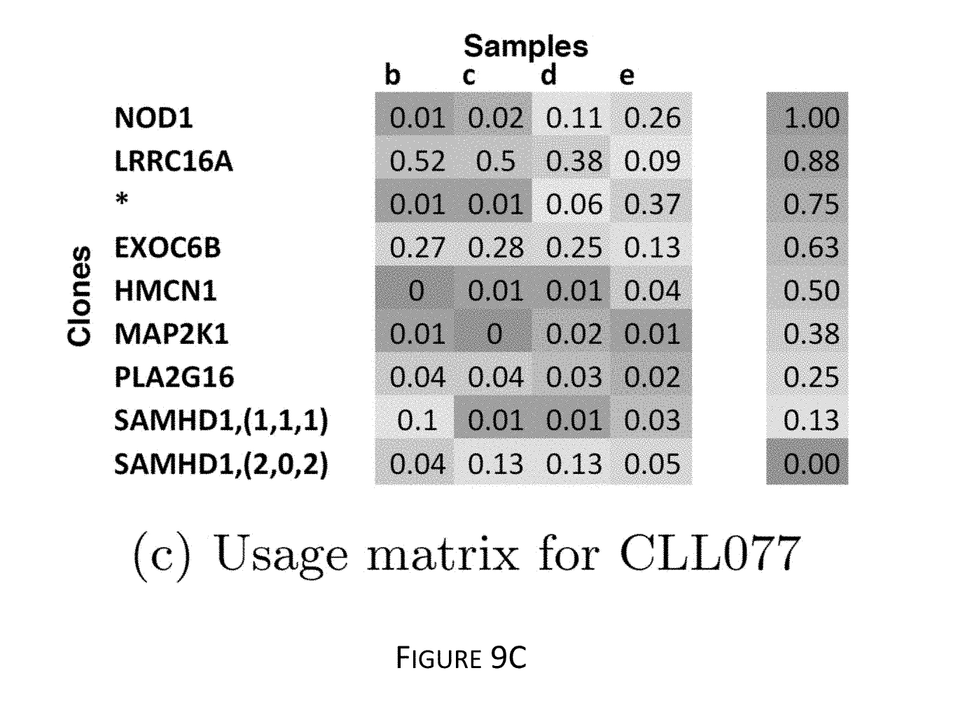

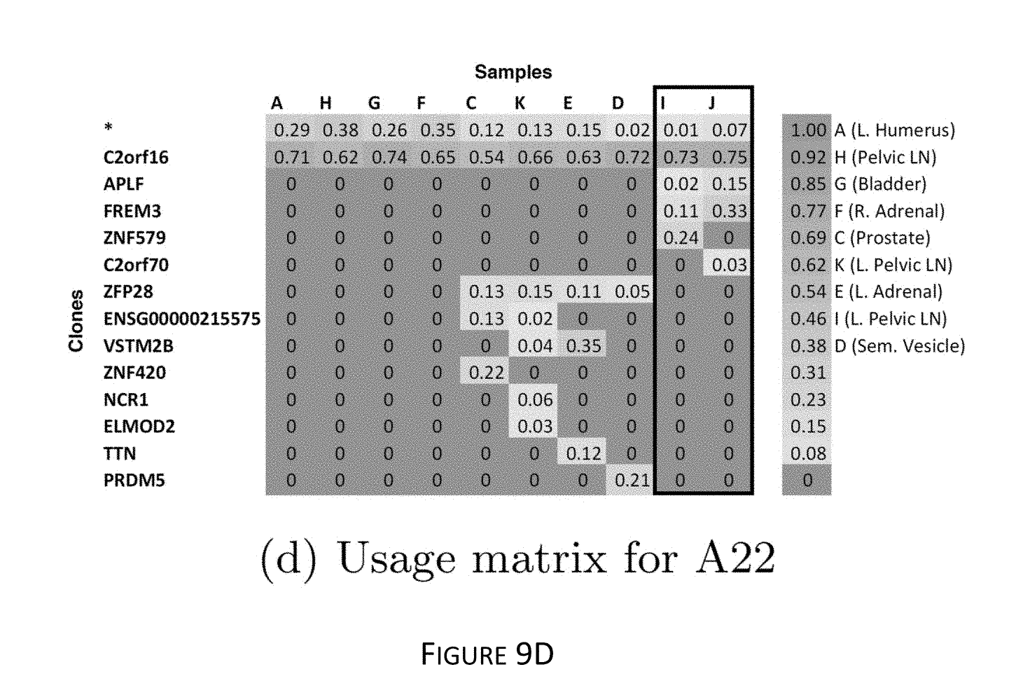

Tumor “CLL077” (Anna Schuh et al., Monitoring chronic lymphocytic leukemia progression by whole genome sequencing reveals heterogeneous clonal evolution patterns. Blood, 120(20):4191-6, November 2012). We used targeted and whole-genome sequencing data from four time-separated samples (b, c, d, e). The targeted data includes 14 SNVs, one of which (SAMHD1) is classified as a CN-LOH in all four samples. Two SNVs (in genes BCL2CB and NAMPTL) were classified as being unaffected by CNAs, but in some of the samples they had had a VAF confidence interval greater than 0.5 and as such were incompatible with all state trees. The 12 remaining characters had only one compatible state tree associated with them. We ran NoisyEnumerate until completion, and thus enumerated the entire solution space, which consists of 20 trees of nine vertices as shown in FIG. 8a. FIG. 9a shows one tree from the solution space. A similar tree with two branches is also reported by PhyloSub (Wei Jiao et al., Inferring clonal evolution of tumors from single nucleotide somatic mutations. BMC Bioinformatics, 15:35, 2014), PhyloWGS (Amit G Deshwar et al., PhyloWGS: Reconstructing subclonal composition and evolution from whole-genome sequencing of tumors. Genome biology, 16(1):35, February 2015), CITUP (Salem Malikic et al., Clonality inference in multiple tumor samples using phylogeny. Bioinformatics, January 2015) and AncesTree [Mohammed El-Kebir et al., Reconstruction of clonal trees and tumor composition from multi-sample sequencing data. Bioinformatics, 31(12):i62-i70, June 2015) for this dataset. However, the tree reported here and the one reported by AncesTree predict the order of all the mutations on each branch, while PhyloSub, PhyloWGS and CITUP group some mutations together. Additionally, AncesTree did not consider the SNV in gene SAMHD1, as its VAF>0.5. Here, we reconstruct a tree containing the CN-LOH event on SAMHD1.

By enumerating the entire search space, we can detect ambiguities in the input data. For instance, in our tree LRRC16A is a child of EXOC6B whereas there are solutions which assign LRRC16A as a child of either OCA2 or DAZAP1 (which is absent in the shown tree). Without additional data or further assumptions, there is not enough information to distinguish between these ancestral relationships. In contrast, by only providing one solution, AncesTree and CITUP give an incomplete picture that does not reflect the true uncertainty inherent to the data.

### Example 4

Prostate Cancer Tumor

Tumor “A22” Gunes Gundem et al., The evolutionary history of lethal metastatic prostate cancer. Nature, 520(7547):353-357, April 2015). We considered a solid prostate cancer tumor (“A22”) where 10 samples were taken from the primary tumor and different metastases. The number of SNVs is 114. Applying THetA showed that this tumor is highly rearranged. We considered only SNVs that are in regions classified as CN-LOH or SCD across all samples and whose VAFs are greater than 0.01 in all samples. This resulted in a set of 27 SNVs.

We restricted the enumeration to N=10⁶ maximal trees. NoisyEnumerate finds 24,288 solutions comprised of 20 vertices (FIG. 8). FIG. 9b shows a representative tree of the solution space, i.e. the solution tree that shares the largest number of edges with other trees in the solution space. This tree has a SCD event containing gene FREM2, which has a VAF>0.5 in 8 of 10 samples. Since a VAF>0.5 for an SNV violates the assumption of two-state perfect phylogeny, methods that use this assumption will disregard this locus. In the inferred tree, the parent of FREM2 is C2orf16, but the VAF of the SNV in this gene is lower than FREM2 in every sample. Thus, the VAFs of SNVs in isolation provide insufficient evidence to infer the ancestral relationship between FREM2 and C2orf16, whereas combining the VAFs with BAFs and read-depth ratios allows us to do so.

FIG. 9d shows the usage matrix for this solution. In contrast to the CLL tumor, we do not expect the clones to be well mixed, since the primary tumor is a solid tumor and the metastases samples are physically separated from the primary tumor. Indeed, we find clones that are specific to certain samples and that there is no sample consisting of all clones. In addition, we see that certain samples are more similar to each other in terms of their usages. In particular, samples I and J only differ in two clones and both correspond to pelvic lymph nodes. In summary, we find that the samples consist of small subsets of clones that reflect that they correspond to distinct spatial locations of the samples.

This disclosure described some embodiments of the present technology with reference to the accompanying drawings, in which only some of the possible embodiments were shown. Other aspects can, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

1. A method for generating character-based phylogeny trees from heritable data for at least one mixture sample, the method comprising:
generating a plurality of character-state trees based on the data, each of the character-state trees comprising an arrangement of character-states associated with a particular character;
generating a pairwise compatibility graph for the character-state trees;
identifying at least one maximal clique within the pairwise compatibility graph; and
generating at least one phylogeny tree based on the identified at least one maximal clique.

2. The method of claim 1, wherein the heritable data comprises genetic data.

3. The method of claim 2, wherein the genetic data comprises nucleic acid sequencing data.

4. The method of claim 3, wherein the nucleic acid sequencing data comprises DNA sequencing data.

5. The method of claim 3, wherein the nucleic acid sequencing data comprises RNA sequencing data.

6. The method of claim 1, wherein the heritable data comprises epigenetic data.

7. The method of claim 6, wherein the epigenetic data comprises DNA methylation data.

8. The method of claim 6, wherein the epigenetic data comprises histone modification data

9. The method of claim 1, wherein at least one character represented in the plurality of character-state trees has more than two states.

10. The method of claim 9, further comprising:
generating a frequency tensor based on the data, the frequency tensor comprising frequency values for a plurality of characters in a plurality of character-states for each mixture sample of the at least one mixture sample.

11. The method of claim 1, wherein identifying at least on maximal clique comprises identifying a maximum clique within the pairwise compatibility graph.

12. The method of claim 1, wherein the pairwise compatibility graph comprises vertices corresponding to the plurality of character state trees and wherein generating a pairwise compatibility graph for the character state trees comprises:
selecting a character state tree for a first character;
selecting a character state tree for a second character;
determining whether a multi-state perfect phylogeny tree exists that contains both the selected character state tree for the first character and the selected character state tree for the second character; and
when determined that a multi-state perfect phylogeny tree exists that contains both the selected character state tree for the first character and the selected character state tree for the second character, adding an edge to the pairwise compatibility graph between a vertex associated with the selected character state tree for the first character and a vertex associated with the selected character state tree for the second character.

13. The method of claim 1, wherein the at least one maximal clique is used to identify a set of character state trees that are all compatible with each other.

14. The method of claim 1, wherein the data comprises variant allele frequencies of single nucleotide variants.

15. The method of claim 1, wherein the data comprises breakpoint frequencies of structural variants.

16. The method of claim 1, wherein the data comprises copy number data including read-depth ratios and B-allele frequencies from copy number aberrations.

17. The method of claim 1, wherein the data comprises nucleic acid mutation frequency data.

18. A system for generating character-based phylogeny from heritable data for at least one mixture sample, the system comprising:
at least one processor; and
memory, operatively connected to the at least one processor and storing instructions that, when executed by the at least one processor, cause the at least one processor to:
generate a plurality of character-state trees based on the data, each of the character-state trees comprising an arrangement of character-states associated with a particular character;
generate a pairwise compatibility graph for the character-state trees;
identify at least one maximal clique within the pairwise compatibility graph; and
generate at least one phylogeny tree based on the identified at least one maximal clique.

19-21. (canceled)

22. The system of claim 18, wherein the pairwise compatibility graph comprises vertices corresponding to the plurality of character state trees and wherein the instructions that cause the at least one processor to generate a pairwise compatibility graph for the character state trees comprise instructions to:
select a character state tree for a first character;
select a character state tree for a second character;
determine whether a perfect phylogeny tree exists that contains both the selected character state tree for the first character and the selected character state tree for the second character; and
when determined that a perfect phylogeny tree exists that contains both the selected character state tree for the first character and the selected character state tree for the second character, add an edge to the pairwise compatibility graph between a vertex associated with the selected character state tree for the first character and a vertex associated with the selected character state tree for the second character.

23-37. (canceled)

38. A method for generating character-based phylogeny trees from sequencing data for at least one mixture sample, the sequencing data comprising variant allele frequencies of single nucleotide variants, breakpoint frequencies of structural variants, copy number data, and nucleic acid mutation frequency data, the method comprising:
generating a frequency tensor based on the sequencing data, the frequency tensor comprising frequency values for a plurality of characters in a plurality of character-states for each mixture sample of the at least one mixture sample;
generating a plurality of character-state trees vertices corresponding to the plurality of character state trees based on the sequencing data, each of the character-state trees comprising a sequence of character-states associated with a particular character;
generating a pairwise compatibility graph having vertices corresponding to the plurality of character state trees by:
selecting a character state tree for a first character;
selecting a character state tree for a second character;
determining whether a perfect phylogeny tree exists that contains both the selected character state tree for the first character and the selected character state tree for the second character; and
when determined that a perfect phylogeny tree exists that contains both the selected character state tree for the first character and the selected character state tree for the second character, adding an edge to the pairwise compatibility graph between a vertex associated with the selected character state tree for the first character and a vertex associated with the selected character state tree for the second character; and
identifying at least one maximal clique within the pairwise compatibility graph; and
generating at least one phylogeny tree based on the identified at least one maximal clique, wherein the sequencing data for the at least one mixture sample comprises bulk nucleic acid sequencing data for the at least one mixture sample and the copy number data comprises read-depth ratios and B-allele frequencies from copy number aberrations.
